(19) United States
(12) Patent Application Publication
(10) Pub. No.: US 2015/0096676 A1
(43) Pub. Date: Apr. 9, 2015

(54) LABELLING MACHINE FOR LABELS PRINTED ON CONTINUOUS FILM

(71) Applicant: P.E. LABELLERS S.p.A., Porto Mantovano (IT)

(72) Inventor: Mario Ballarotti, Marmirolo (IT)

(21) Appl. No.: 14/568,406

(22) Filed: Dec. 12, 2014

Related U.S. Application Data
(62) Division of application No. 13/512,541, filed on May 29, 2012.

(30) Foreign Application Priority Data
Dec. 2, 2009 (IT) MI2009A002130

(51) Int. Cl. B65C 9/18; B65C 9/40; B65C 9/30; B65C 3/06; B65C 9/04

(52) U.S. Cl. CPC B65C 9/1803; B65C 3/06; B65C 9/04; B65C 9/30; B65C 9/40; B65C 2009/1846
USPC 156/256

(57) ABSTRACT

A method for labelling containers with labels printed on a continuous film. The method comprises supplying individual containers to be labelled on a support of a rotating carousel; turning the containers about their own axis by turning the support; providing a reel of printed continuous film pretreated with adhesive and unwinding the film; aligning and adjusting the tension of the film; feeding the film to a rotating drum by a feeder; receiving and retaining, on the rotating drum, the film from the feeder so that the film adheres to the drum surface; programming a desired label length; cutting the film on the rotating drum with a laser head at the desired label length; separating the cut individual labels and moving them into contact with corresponding containers supported by the support of the carousel; and applying the individual labels to the corresponding containers directly from the rotating drum.

### CROSS-REFERENCES TO RELATED APPLICATIONS

This application is a division of U.S. patent application Ser. No. 13/512,541 filed May 29, 2012, and claims the benefit of the PCT Application No.PCT/EP2010/068152 filed Nov. 24, 2010, and of the Italian patent application No. MI2009A002130 filed on Dec. 2, 2009, the entire disclosures of which are incorporated herein by way of reference.

### BACKGROUND OF THE INVENTION

The present invention relates to a labelling machine for labels printed on continuous film.

Labelling machines are known that are designed for the application on containers of labels printed on a continuous film that is wound in the form of a reel.

Such machines comprise a rotating carousel provided with supporting plates for the individual containers, adapted to turn the containers about their own axis, and the continuous film that unwinds from the reel arrives, after being passed through several devices that ensure its alignment and correct tension, at a rotating drum provided with blades which is adapted to receive and retain, so that it clings to its own surface, the film in order to cut the labels and bring the individual labels, separated after cutting, into contact with corresponding containers supported by the carousel. The rotating drum is called “cutting and transfer drum”.

Such machines have a disadvantageous characteristic which consists in a major lack of functional flexibility, as will be explained in detail hereinafter, because they can function correctly only if they are used to operate on labels of length proximate to an optimal length; only in this case are the containers designed to receive the labels imparted a rotation speed about their own axis which first and foremost does not cause problems of stability for the containers which feature increasingly lower characteristics of resilience, and also ensures a good quality of tack of the label.

### SUMMARY OF THE INVENTION

An aim of the present invention is to devise a labelling machine that is provided with optimal characteristics of functional flexibility, so as to be capable of operating correctly on labels that have different lengths while still ensuring optimal values of the speed of rotation of the containers intended to receive the labels about their own axis.

This aim and other objects that will become apparent hereinafter are achieved by a labelling machine for labels printed on continuous film, according to the invention, characterized in that it comprises the features disclosed in the appended claims.

### BRIEF DESCRIPTION OF THE DRAWINGS

Further characteristics and advantages of the invention will become better apparent from the description of a preferred, but not exclusive, embodiment of the invention, illustrated by way of non-limiting example in the accompanying drawings wherein:

FIG. 1 shows a schematic plan view of a conventional labelling machine, with the containers absent;

FIGS. 2 and 3 show a detail of FIG. 1 in two different operational conditions;

FIG. 4 shows the same detail, after changing the cutting and transfer drum;

FIG. 5 shows a schematic plan view of the machine according to the invention.

### DETAILED DESCRIPTION OF THE PREFERRED EMBODIMENTS

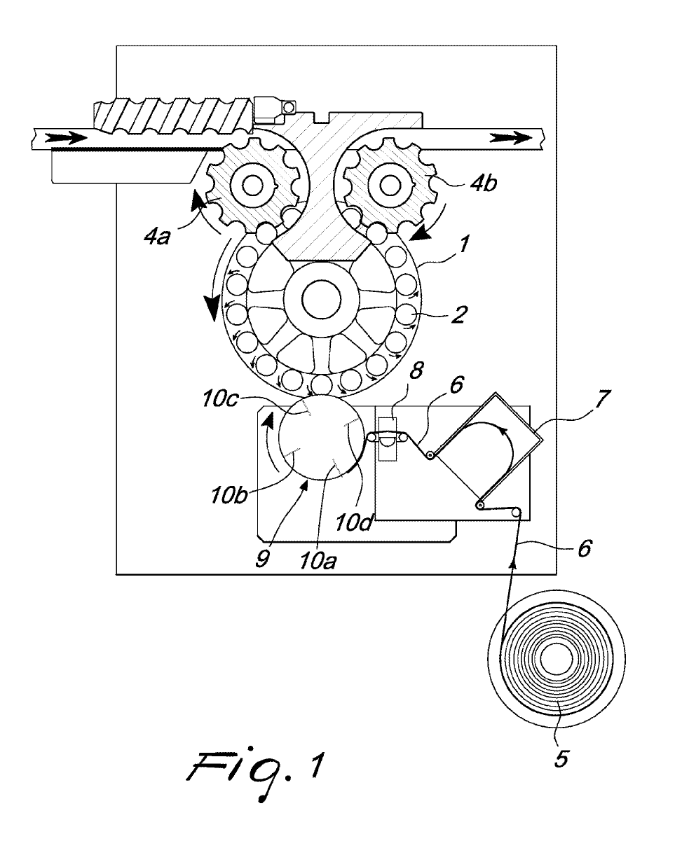

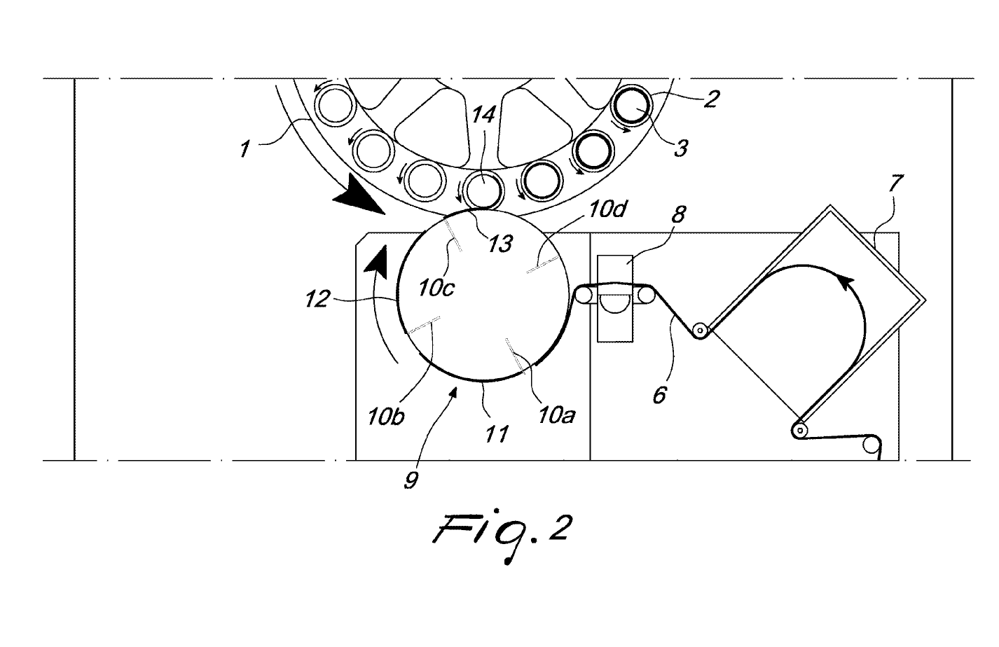

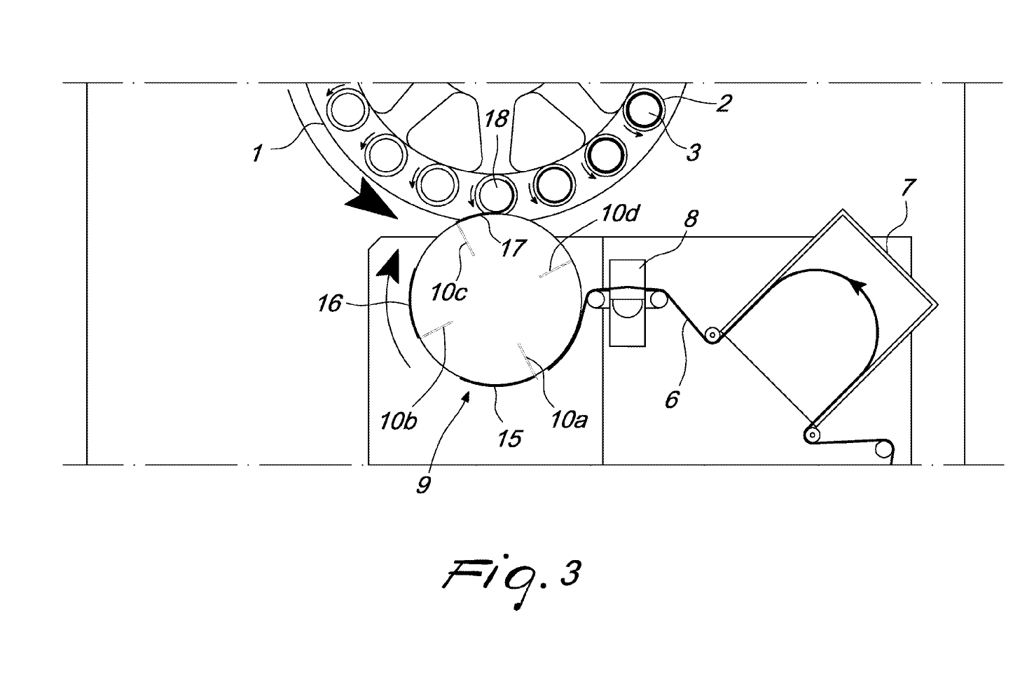

FIG. 1 with the details shown in FIGS. 2 and 3 represents, as mentioned above, a conventional labelling machine with the containers to be labelled absent.

The machine comprises a carousel 1 which rotates in the direction of the arrow, and is provided with supporting plates 2 for individual containers 3 shown in the following figures, turned about their own axis according to the arrows in the figure. The containers are arranged to arrive at the supports of the carousel by means of an intake star wheel 4a, and to be removed by means of an exit star wheel 4b.

The reference numeral 5 indicates a reel of film 6, which is pretreated with adhesive, that continuously produces the printed labels.

Upon unwinding from the reel 5, the film 6 passes to a device 7 for alignment and adjustment of tension and to a feeder 8, and finally arrives at a cutting and transfer drum 9 provided with four blades 10a, 10b, 10c, 10d which are supported by it and which cut the individual labels that remain clinging to the drum by way of a suction device with which it is provided, and the labels are transferred to the individual containers.

The drum 9 has a diameter of 540 mm, and it is assumed that it is desired to achieve a production rate of 12,000 containers per hour.

FIG. 2 shows the situation in which the machine operates on labels, which for practical purposes will be called “long labels”, which have a length of 400 mm which approximates to the distance, referred to as “pitch”, between two of the blades of the drum 9. Labels 11 and 12, already cut, can clearly be seen comprised respectively between blades 10a, 10b and 10b, 10c, and it can clearly be seen that a label 13 is being applied to a container 14.

Straightforward calculations show that the speed of rotation about their own axis of the individual containers 3 supported by the pans 2 of the carousel 1 is 141.60 revolutions per minute which is considered more than acceptable.

But if the machine as described is used to operate on labels, which for practical purposes will be called “short labels”, which have a length of 172 mm, i.e. clearly shorter than the pitch of the blades, as can be seen in FIG. 3 which shows labels 15 and 16 still clinging to the drum and a label 17 being applied to a container 18, calculations show that the speed of rotation of the individual containers about their own axis is 345.50 revolutions per minute, and this speed is no longer acceptable.

It clearly appears that the optimal operating characteristics are obtained only when using those labels called “long labels” which, by approximating in length substantially the pitch of the blades of the cutting and transfer drum, ensure a high exploitation of the supporting surface on the drum, while operation when using those labels that we have called “short labels”, which leave wide areas of the supporting surface unused, is problematic.

It clearly appears that the machine as described displays a major drawback in terms of functional flexibility, and certainly the means used nowadays to remedy this drawback are not optimal, as for example is the case with the provision of changing the cutting and transfer drum mounted on the machine, with burdens that can be easily imagined.

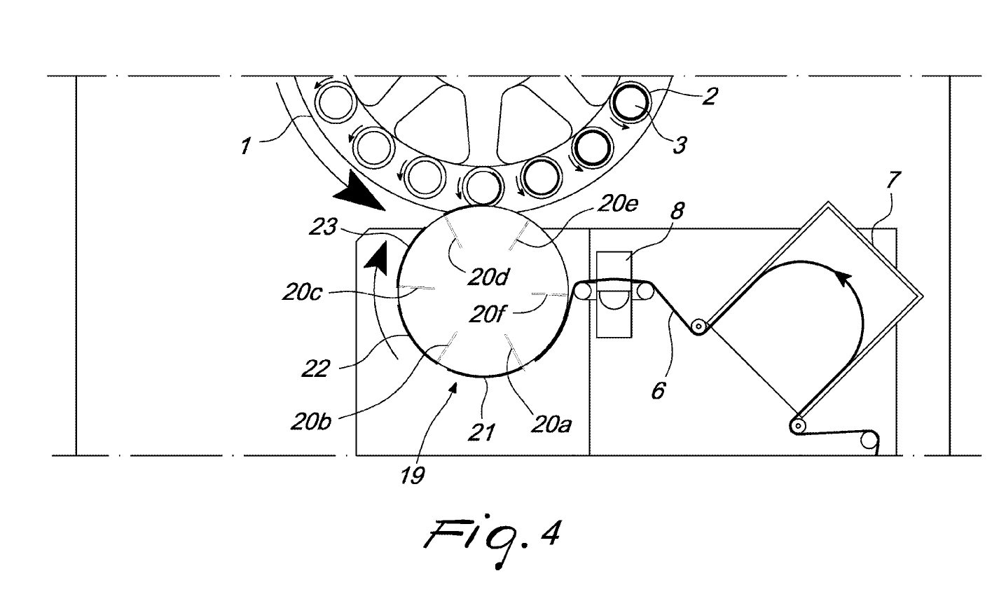

In view of the example described above with reference to FIG. 4, straightforward calculations show, again based on an assumed production rate of 12,000 containers per hour, that by replacing the drum 9 with a drum 19 which also has a diameter of 540 mm but which is provided with six blades 20a, 20b, 20c, 20d, 20e and 20f, it is possible to operate on labels such as 21, 22, 23 which have a length of 172 mm, which for practical purposes we have called “short labels”, imparting to the containers to be labelled a speed of rotation about their own axis that is equal to 165.50 revolutions per minute which can be considered acceptable but which has been achieved by actually resorting to a burdensome change of the cutting and transfer drum.

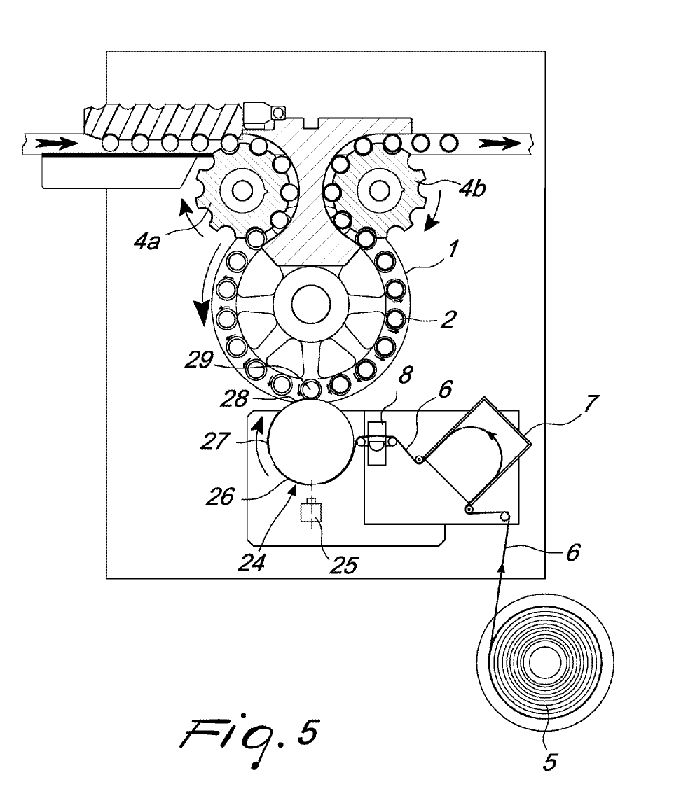

All this is overcome by the machine according to the invention which shall now be described with reference to FIG. 5.

This machine also features the carousel 1 provided with supporting means such as supporting plates 2, turned about their own axis, which are adapted to support individual containers 3 conveyed by respectively an intake star wheel 4a and an exit star wheel 4b, and a film 6 still unwinds from a reel 5 that continuously produces the printed labels and it passes to a device 7 for the alignment and adjustment of the tension and to a feeder 8 in order to arrive at a drum 24 which rotates in the direction of the arrow in the figure.

The drum 24, which is not provided with blades, then receives the film 6 and retains it, so that it clings to its own surface, thus making it available to the cutting action performed by a laser head 25 which, thanks to suitable methods of operation of the feeder 8, will perform the cut of the film at the separation line between two consecutive labels. In this way a situation is brought about by which the individual labels are arranged, keeping a minimum mutual distance such as to ensure a good labelling, supported on the surface of the drum 24 which transfers them to respective containers which are present on the supporting plates of the carousel 1 according to what is seen in the figure which shows a label 26, which has just been cut, and the previous labels 27 and 28, this last being applied to a container 29, in close proximity.

Therefore it is evident that the labels can be indifferently “long” and “short” because, no matter what the length is of the label that is cut, the condition is achieved of a high exploitation of the supporting surface on the drum, which we have seen achieves optimal operating conditions of the machine thereby provided with an exceptionally high degree of flexibility.

Given that the film pretreated with adhesive as mentioned above can be heat-shrinking or non-heat-shrinking indifferently, and given that in any case the machine according to the invention is also adapted to operate on film designed to be spread with adhesive after the labels are cut, attention is drawn to the fact that this machine makes it possible, following suitable programming, to cut labels of different lengths consecutively.

It is finally observed that the laser head is positioned on the machine in a position that is variable both radially and circumferentially, so as to enable it to be fixed in the best condition according to the material of the film to be handled, and according to the size of the labels.

The labelling machine as described is susceptible of numerous modifications and variations, all of which are within the scope of the appended claims.

Moreover, all the details may be replaced with other technically equivalent elements.

The disclosures in Italian Patent Application No. MI2009A002130 from which this application claims priority are incorporated herein by reference.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

1. A method for labelling containers with labels printed on a continuous film, comprising:
supplying individual containers to be labelled on supporting means of a rotating carousel;
turning said containers about their own axis by turning said supporting means;
providing a reel of printed continuous film pretreated with adhesive and unwinding said film from the reel;
aligning and adjusting the tension of the film that unwinds from the reel; feeding said film to a rotating drum by a feeder;
receiving and retaining on said rotating drum the film that exits from said feeder so that the film adheres to the surface of said drum;
programming a desired label length;
cutting said film on said rotating drum with a laser head according to the desired label length;
separating the individual labels after said cutting and moving them into contact with corresponding containers supported by the supporting means of the carousel; and
applying the individual labels to the corresponding containers directly from said rotating drum.

2. The method according to claim 1, further comprising the step of varying position of the laser head both radially and circumferentially so as to face the rotating drum in a variable position according to the size of the labels.
